(19) United States
(12) Patent Application Publication
(10) Pub. No.: US 2011/0219050 A1
(43) Pub. Date: Sep. 8, 2011

(54) PORTABILITY OF PERSONAL AND SOCIAL INFORMATION IN A MULTI-TENANT ENVIRONMENT

(75) Inventors: Yip LY, San Jose, CA (US); Alfred S. Chuang, Los Altos Hills, CA (US)

(73) Assignee: Kryptonite Systems, Inc., Palo Alto, CA (US)

(21) Appl. No.: 12/717,782

(22) Filed: Mar. 4, 2010

(51) Int. Cl. G06F 17/30

(52) U.S. Cl. 707/827; 707/E17.032

(57) ABSTRACT

Systems and processes for transferring user profile data from tenant-to-tenant in a multi-tenant database system, e.g., associated with an enterprise business application and/or social networking application are described. Apparatus may include a multi-tenant database system operable to store data for a plurality of tenants and a processor operable to logically separate and provide access to certain data for the plurality of tenants. The processor further operable to transfer at least some profile information associated with a user from a first tenant to a second tenant of the multi-tenant database system, such that profile information (such as personal contacts and other information) follows the user. The multi-tenant database system may be associated with, or include, a social networking application, Customer Relationship Management (CRM) application, or both.

### BACKGROUND

1. Field

This application relates generally to systems and processes for multi-tenant database environments, and in one particular example, to computer systems and processes for transferring or associating information from one tenant database to another within a multi-tenant database system.

2. Related Art

In conventional database systems, it is common that a plurality of tenants (e.g., companies or customers) share a common database infrastructure, e.g., sharing various elements of hardware and/or software of the database system. Such database systems are often referred to as “multi-tenant” database architectures or systems. Multi-tenant database systems generally enable database related services to be provided at a far lower cost than if each tenant were allocated, or had to buy, hardware and software for themselves.

In such multi-tenant database systems it is highly desirable to assure that a tenant's data remains secure and only visible and updatable by appropriate users associated with a particular tenant. Accordingly, tenant data is typically arranged such that data for each tenant is kept logically separate from that of other tenants so that one tenant does not have access to another tenant's data, unless the data is shared or access is granted. As such, multi-tenant database systems include various governance policies to ensure data associated with a tenant, e.g., including company information, messages, documents, and the like, as well as information of a user associated with a tenant, e.g., user profile information, is logically separated from other tenants.

### SUMMARY

In one exemplary aspect of the present invention, an apparatus and process for transferring user profile information within a multi-tenant database system are described. The apparatus may include a multi-tenant database system operable to store data for a plurality of tenants and a processor operable to logically separate and provide access to certain data for the plurality of tenants. The processor is further operable to transfer or preserve at least some profile information associated with a user from a first tenant to a second tenant of the multi-tenant database system when the user becomes associated with (or hosted by) the second tenant. In this fashion some or all of a user's profile information follows a user within a multi-tenant database system across multiple tenancies.

Transferring user profile information may be in response to a user becoming associating with a new tenant. In other examples, transferring user profile information may be in response to a request by the user or a tenant. Transferring of profile information may include logically moving or changing the association of the profile information from the first tenant to the second tenant.

In some examples provided herein, the multi-tenant database system is associated with, or includes, a social networking application. The social networking application may include, for example, a business or sales oriented, web-based, social networking site. The social networking application may generally provide for building a network of contacts and connections, explore employment and business opportunities, and so on. In one example, the multi-tenant database system is associated with, or includes, a web-based Customer Relationship Management (CRM) application. In one example, the multi-tenant database system is associated with, or includes, a social networking application in combination with a CRM application.

User profile information may include personnel or social information such as a user name, notes, contacts, tasks, connections, social networks or groups, activity data, deal information, frequency of deal participation, messages posted, documents published, emails or messages exchanged, affinity data, and so on. In some examples, the apparatus and method include transferring only a portion of the user's profile information and filtering or preventing the transfer of certain data, e.g., that is owned or confidential to a particular tenant.

Exemplary multi-tenant database systems and methods may provide governance of private information, as desired by particular tenants, combined with social connectivity and sharing of information for users of the multiple tenants within the system. Additionally, the exemplary system may allow user flexibility to host or port to another tenant (or a default tenant) and transfer some or all of the profile information intact. For example, some or all of a user's profile information can be stored as (or temporarily made) non-private information with respect to tenants such that the user can seamlessly move from one tenant to another, including the default tenant, e.g., during periods where the user is not associated with a hosted tenant of the multi-tenant database system.

According to other embodiments, systems, apparatuses, and computer-readable storage media comprising computer-readable instructions for transferring user profile information within a multi-tenant database system are provided. For example, a computer-readable storage medium may include computer-readable instructions for transferring user profile information within a multi-tenant database system as part of a social networking application and/or CRM application.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary environment in which certain aspects and examples of the user interfaces, apparatuses, and processes described herein may operate.

FIG. 2 schematically illustrates an exemplary multi-tenant database system having separated tenants, each tenant having a set of users associated therewith.

FIG. 3 illustrates an exemplary process for entering and transferring a user's profile information from a first tenant to a second tenant.

FIG. 4 illustrates an exemplary process for a single user registering with a multi-tenancy database system and building personal profile information.

FIGS. 5 and 6 illustrate exemplary processes and actions by a user associated with a tenant.

FIG. 7 illustrates an exemplary computing system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

Multi-tenancy database systems, where separate tenants are served from a common infrastructure in which various components are shared (e.g., shared operating systems, databases, etc.), are well-known. For example, a common or shared infrastructure may service different tenants (e.g., companies); the common infrastructure including security to separate and safeguard one tenant's information from other tenants. With each tenant there are typically multiple users, each with their own associated profile information, e.g., personnel or social information such as name, notes, contacts, tasks, connections, social networks or groups, activity data, instant messaging contact/chat information, deal information, frequency of deal participation, messages posted, documents published, emails or messages exchanged, affinity data, and so on. As a user moves from one tenant to a new tenant, e.g., from one company to another, or from an individual tenant to a company, the user's profile information is typically left with the former tenant, inaccessible to the other tenants by the security of the multi-tenancy database system for safeguarding and separating information between different tenants. Accordingly, a user moving from one tenant to another generally leaves behind their profile information and reenters or re-registers their personal information with the new tenant. For example, a user typically must copy all of their profile information, including contacts, notes, connections, etc., and import them into a new profile with the new tenant. Further, social network groups and connections may be lost in such a transition and have to be reintroduced by the user for association with the new tenancy.

In one exemplary process provided herein, at least a portion of a user's profile information (e.g., including personal information and social information) is portable across different, separated tenants, thereby moving with the user. For example, if a user moves from tenant A to tenant B within a multi-tenant database system, the user's personal and/or social information is moved and accessible to the user within tenant B. As such, a user's profile information is transferrable with the user and does not need to be copied and reentered when moving from one tenancy to another. Additionally, individual users, e.g., of a social network application associated with the multi-tenancy system, may initially enter or generate profile information and subsequently join a company tenant and have their profile information follow them to the company tenancy. Further, in some examples, if a user leaves a particular tenant without a new tenant destination, the user's profile information is maintained with the multi-tenant database system, for example, in a default tenancy, whereby the user may continue to have access to profile information (e.g., contacts and social networks) and interact with other users without being associated with a particular company serving as a tenant with the multi-tenancy system.

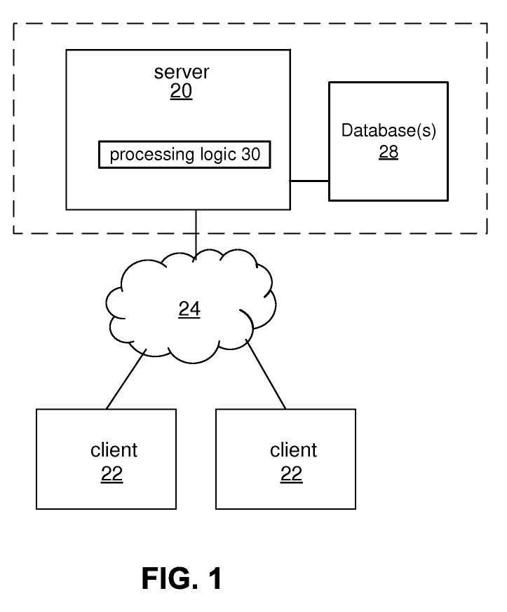

Initially, and with reference to FIG. 1, an exemplary environment in which certain aspects and examples of the user interfaces, apparatuses, and processes described herein may operate. Generally, one or more clients 22 may access a server 20, which includes or accesses logic for performing one or more exemplary processes described, e.g., providing multi-tenancy provisioning, governance, and security, transferring user profile information from one tenant to another, causing the display of interfaces, and so on. Server 20 and clients 22 may include any one of various types of computer devices, having, e.g., a processing unit, a memory (which may include logic or software for carrying out some or all of the functions described herein), and a communication interface, as well as other conventional computer components (e.g., input device, such as a keyboard/keypad and/or mouse, output device, such as display). For example, client 22 may include a desktop computer, laptop computer, mobile device such as a mobile phone, web-enabled phone, smart phone, television, television set-top box, and the like.

Clients 22 and server 20 may communicate, e.g., using suitable communication interfaces via a network 24, such as a Local Area Network (LAN) or the Internet. Clients 22 and server 20 may communicate, in part or in whole, via wireless or hardwired communications, such as Ethernet, IEEE 802.11b wireless, or the like. Additionally, communication between clients 22 and server 20 may include or communicate with various servers such as a mail server, mobile server, media server, and the like.

Server 20 generally includes logic (e.g., http web server logic) or is programmed to format data, accessed from local or remote databases or other sources of data and content, for presentation to users of clients 22, preferably in the format described herein. For example, server 20 may format data and/or access a local or remote database to communicate and cause the display of an interface to clients 22, data related to objects for display within an interface (which may include a search interface and display window for displaying objects, for example), links to additional information and/or content related to the objects, the additional content and/or information itself, and the like.

To this end, server 20 may utilize various web data interface techniques such as Common Gateway Interface (CGI) protocol and associated applications (or “scripts”), Java® “servlets”, i.e., Java® applications running on a web server, or the like to present information and receive input from clients 22. The server 20, although described herein in the singular, may actually comprise plural computers, devices, databases, associated backend devices, and the like, communicating (wired and/or wireless) and cooperating to perform some or all of the functions described herein. Server 20 may further include or communicate with account servers (e.g., email servers), mobile servers, photo servers, video servers, and the like.

Further, web pages communicated to client 22 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by client 22 via a presented web page may conform to any suitable data format including various media formats such, e.g., still image (e.g., JPEG, TIFF), video (e.g., MPEG, AVI, Flash), or audio (e.g., MP3, OGG).

In one example, server 20 may further include or communicate with processing logic 30 for implementing a multi-tenant database system and a Web-based Customer Relationship Management (CRM) system. For example, server 20 may include one or more application servers configured to implement and execute CRM software applications as well as provide related data, code, forms, web pages, and other information to and from clients 22 and to store to, and retrieve from, a database system related data, objects and web page content.

Within a typical multi-tenant database system, tenant data is logically separated from that of other tenants so that one tenant does not have access to another's data, unless such data is expressly shared or access is expressly granted. In one example, server 20 is generally configured to provide web pages, forms, applications, data, and media content to clients 22 as tenants. As such, server 20, e.g., via processing logic 30, provides mechanisms to logically separate each tenant's data (unless the data is shared or access granted). For example, clients 22 may be associated with different tenants, which may be determined by processing logic 30 for appropriate access to data and information. Even within a common tenant, clients 22 may have varying permissions for accessing data (e.g., a salesperson and an administrator may have different levels of permission for accessing or editing data within the system), which may be controlled by processing logic 30.

Additionally, server 20, e.g., via processing logic 30, is operable to port or transfer the association of user profile information from one tenant to another tenant or to a default tenant (where the tenant may include only the particular user or be associated with a social network application). That is, server 20 may operate to allow for portability of a user's profile information as a user moves from one tenant to another tenant (e.g., from one company to another, from a company to an individual associated with a social network application, or vice versa). Note that the transfer of user profile information may include logically moving or association the data with a new tenant without an actual communication or transfer of the data from one computer or storage memory location to another. Various rules and security may be included to limit the types of user profile information that may be ported from one tenant to another; for example, allowing one or more of contacts, notes, connections, social networks, and the like to be transferred, but not tenant-internal networks or documents.

In some examples, server 30 may include or communicate with applications other than, or in addition to, a CRM application. For instance, server 20 may include one or more application servers configured to implement and execute multi-tenant governance, social networking applications, and/or CRM software applications as well as provide related data, code, forms, web pages, and other information to and from clients 22 and to store to, and retrieve from, a database system related data, objects and web page content.

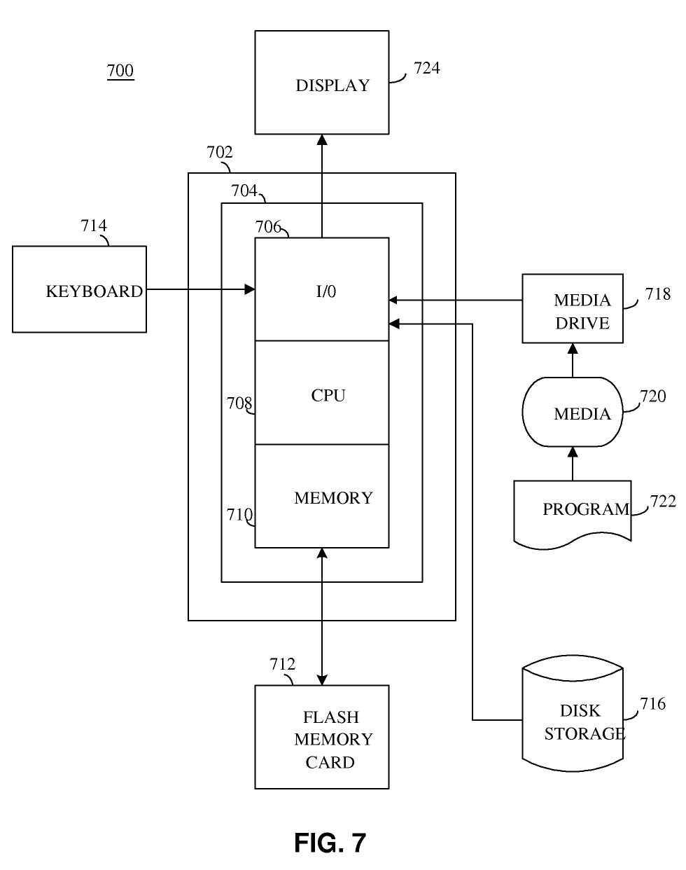

It should be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server 20 and database system 28 generally include such art recognized components as are ordinarily found in server systems, including but not limited to processors, RAM, ROM, clocks, hardware drivers, associated storage, and the like (see, e.g., FIG. 7, discussed below). Further, the described functions and logic may be included in software, hardware, firmware, or combination thereof.

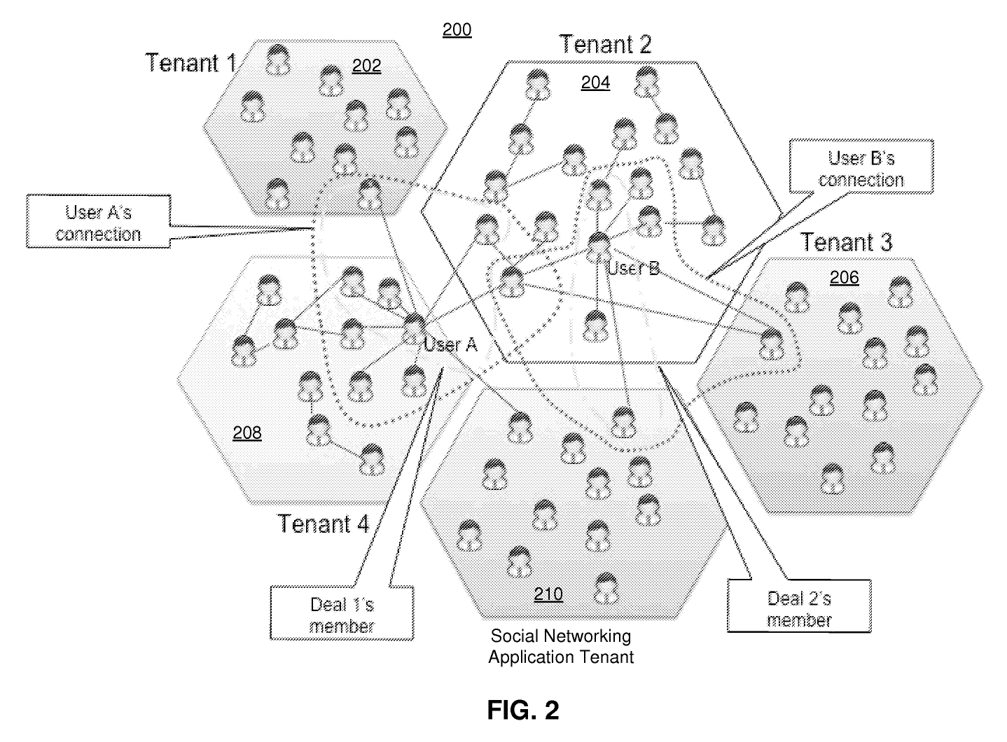

FIG. 2 schematically illustrates an exemplary multi-tenant database system 200; for example, schematically illustrating separated tenants (each having a set of users associated therewith) associated with a multi-tenancy database architecture. In this example, the multi-tenant database system 200 includes five tenants 202, 204, 206, 208, and 210. Four of the tenants 202, 204, 206, and 208 may include different companies or other organizations, and tenant 210 may include a default tenant, e.g., include a grouping of individual users that are not part of the other tenants 202, 204, 206, and 208, but otherwise registered with the multi-tenant database system 200 as individual users. For example, users may register with multi-tenant database system 200 as a single tenancy or as part of a social networking aspect of multi-tenant database system 200, and interact with other users of multi-tenant database system 200, i.e., users of tenants 202, 204, 206, 208, and 210. Note that users of tenant 210 generally do not share data or have access to other user's data of tenant 210 in the way users of a common tenant 202, 204, 206, and 208 may have. In other examples, multiple default tenants, or separate tenants for each of the users in tenant 210, may be used.

The exemplary multi-tenant database system 200 provides governance of private information, as desired by the particular tenant, combined with social connectivity and sharing of information for users of the multiple tenants within the system. Additionally, the exemplary system may allow user flexibility to host or port to another tenant (or the default tenant) and transfer some or all of the profile information intact. For example, user profile information can be stored as (or temporarily made) non-private information with respect to tenants such that a user can seamlessly move from one tenant to another, including the default tenant, e.g., during periods where the user is not associated with a hosted tenant of the multi-tenant database system. It will be understood that the movement or transfer of profile information generally refers to a logical move of the data from one tenant to another, e.g., associating the profile information with a new tenancy to be accessible according to the multi-tenancy governance and so on.

For example, as illustrated in FIG. 2, User A of tenant 208 may have connections (as illustrated by the dotted line) to users within tenant 208 as well as with users of multi-tenant database system 200 that are outside of tenant 208, e.g., with users of tenants 202, 204, 206, or 210. Similarly, User B of tenant 204 may have connections with users of tenant 204 as well as other tenants, e.g., users of tenants 202, 206, 208, and 210. Additionally, User A (and similarly User B) may be members of deals, projects, social groups, etc., that include users across multiple tenants as indicated by “Deal 1” and “Deal 2.” Certain examples provided herein, allow these relationships, e.g., connections and deals, to move with the user across tenancies.

In some examples, certain deal information, project information, and/or group information may be designated as tenant owned and not movable with a user, even if part of the user's profile information. Accordingly, as a user moves, certain information from their profile information, such as deal information, may be filtered and prevented from transferring to a new tenant.

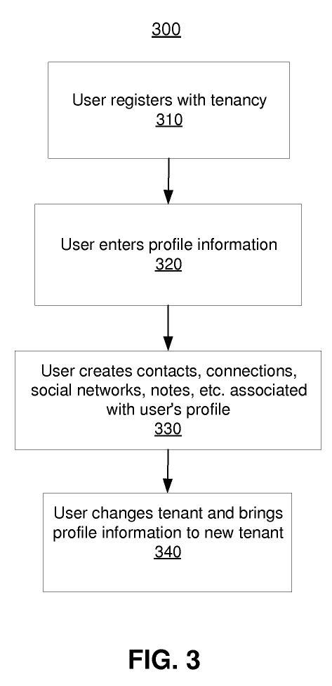

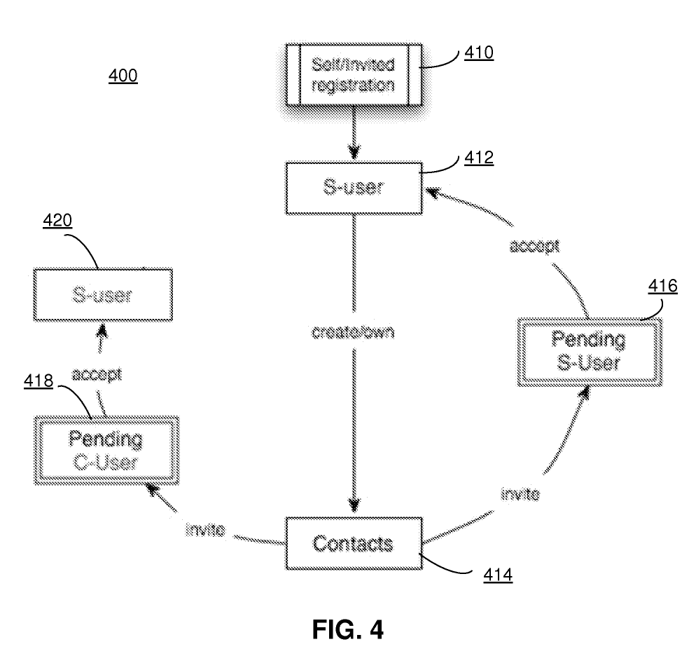

With continued reference to FIG. 2, FIG. 3 illustrates an exemplary process 300 whereby a user joins a first tenancy of a multi-tenant database system and subsequently moves with their profile information to a second tenancy. In this exemplary process, a user initially registers with and joins a tenancy of the multi-tenant database at 310 (e.g., a user joins any of tenants 202, 204, 206, 208, or 210 shown in FIG. 2). For instance, a user may initially register through (or be registered automatically by) a tenant associated with a particular company or organization. In other examples, the user initially joins a default tenancy of the multi-tenant database system. For example, as discussed in greater detail with respect to FIG. 4, a user may sign-up for a social networking application or service associated with a multi-tenant database system.

As part of registering with a tenancy a user enters profile information at 320. The user profile information may be added and edited at the time of registration or later in time. Further, profile information may be manually entered by the user. In other examples, some or all of the profile information may be automatically added to the user's profile information, e.g., adding of a company address or contact information by the multi-tenant database system or associated tenant.

A user may further create information relating to contacts, connections, social networks, personal notes, personal calendar, and other information which may be associated or included with their user profile information at 330. Such data may be entered directly by the user or generated through use, e.g., the system may capture contact information, connection information, social information, and the like through use of the system or applications by the user and associated them with the user profile information.

As a user leaves a tenant for a new tenant, or becomes associated with an additional new tenant, the user's personal information is ported and accessible to the user with the new tenant (whether a default tenancy or a new tenancy) at 340. That is, the user's profile information, e.g., including notes, contacts, tasks, (and other non-confidential tenant information), follows the user to the new tenant. In some examples, a tenant (either the departed tenant or arriving tenant) may include filters or rules for preventing certain information associated with a user's profile from being portable or accessible in the new tenant. For example, information relating to certain deals, notes, messages, or company contacts can be filtered and prevented from being transferred by the multi-tenant database system.

FIG. 4 illustrates an exemplary process for a user registering with a default or social networking portion of a multi-tenancy database system and building personal profile information. For instance, at 410, a user 412 initially registers with social networking application. The social networking application may include, for example, a business or sales oriented, web-based, social networking site. The social networking application may generally provide for building a network of contacts and connections, explore employment and business opportunities, and so on. A user may join the social networking application by signing up and registering via web page, via an invitation from another registered user of the social networking application, and so on. Exemplary aspects of a social networking application are described in co-pending U.S. patent application Ser. No. 12/691,621, entitled “SOCIAL AND CONTEXTUAL SEARCHING FOR ENTERPRISE BUSINESS APPLICATIONS,” and filed on Jan. 21, 2010; the entire content of which is incorporated herein by reference.

In one example, user 412 is assigned or designated in the system as an “S-user,” which designates user 412 as a seller within a CRM application. Other user's in the system may be assigned or designated as a “C-user,” which designates those users as clients. Of course, no designation system need be used, and additional designations may be included, depending on the particular applications and desires of a system.

User 412 may import or create a database of contacts 414, referred to herein as a “rolodex.” For example, user 412 may import contacts from other applications or databases such as from their work or personal address books (e.g., from Outlook™ or a web-based email program). Additionally, contacts may be created by actions of the user, including searching and connecting with other users, inviting new users to the system, and so on. For instance, user 412 may invite user 416 to become a connection or join the social networking application portion of the multi-tenancy database system, thereby connecting user 412 and 416.

User 412 may also invite user 418, e.g., a client of user 412, that is not registered with the social networking application or the multi-tenancy database system. Upon acceptance, user 418 may register and join the social networking application as an “S-user” 420 and begin building contacts and other personal information similar to that of user 412.

In one example, all of the profile information created by user 412 in this exemplary process is “owned” by user 412 and will follow user 412 as user 412 joins and moves across different tenancies. In other examples, as described, certain profile information may not be transferrable depending on particular tenants and governance of the multi-tenancy database system.

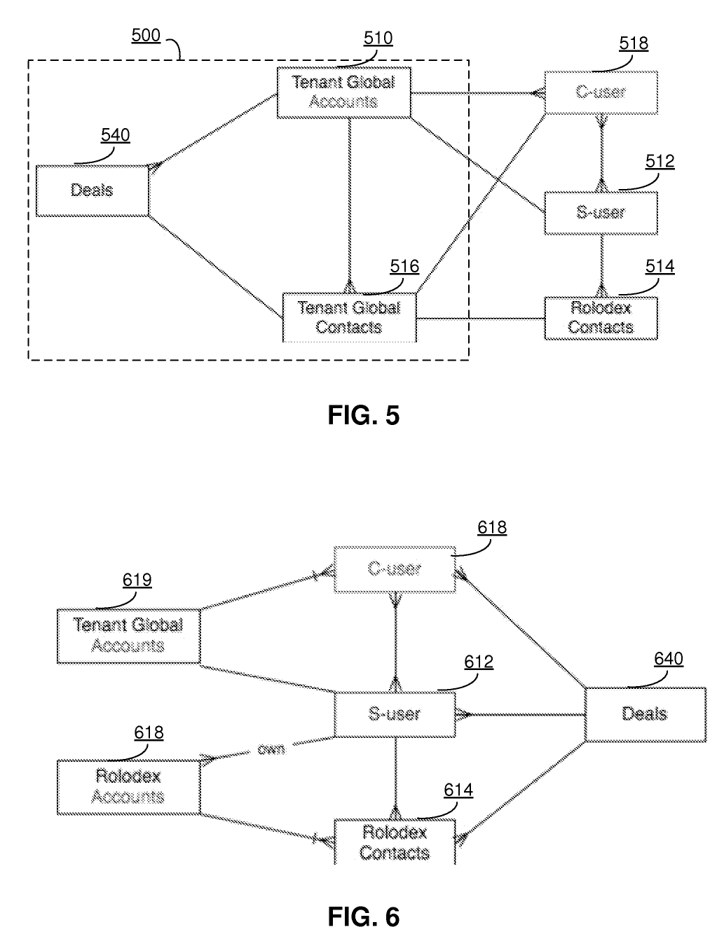

FIGS. 5 and 6 illustrate exemplary processes and relationships of users 512 and 612, respectively, within a tenant of a multi-tenancy database system in one example. In these examples, users 512 and 612 may initially join a social networking application as described with respect to FIG. 4, or joined/registered via the tenant. With references initially to FIG. 5, user 512 is illustrated having access to their rolodex contacts 514, which are part of their personal profile information. User 512 further has access to the tenant's global contacts 516, which may include the tenant's global address book or a subset of the tenant's global address book for which user 512 has been granted access, and the tenant's global accounts 510, which may include information on deals 540 as well as various tenant confidential information, documents, and the like. User 512 might include separate address books or folders to distinguish their personal profile information and contacts from the tenant's information and contacts.

User 512 may further be connected to client user 518, which may be outside of the tenancy and/or multi-tenant database, but have access to certain tenant and user 512 information via their role as a client to the tenant. If user 518 and user 512 are connections, contact and or social information for user 518 may be stored with rolodex contacts 514.

In this example, as user 512 moves to a new tenancy (either another tenant or the default tenant associated with a social networking application, for example) user 512 takes certain profile information to the new tenancy. In particular, in this example, user 512 takes their rolodex contacts 514, which may include their personal contacts, connections, social network information, etc., but does not take information owned by the tenant (referenced here generally by 500) such as tenant global contacts 516, tenant global accounts 510, deals 540, and so on.

FIG. 6 illustrates another exemplary process and relationship structure of a user and tenant within a multi-tenancy database system. Although generally similar to FIG. 5, in this example user 612 owns their personal rolodex contacts 614 as well as certain rolodex accounts 618. That is, certain accounts are owned by user 612 and will transfer or follow user 612 to a new tenancy, whereas certain tenant global account 619 will not. Similarly, user 612 may own or include information relating to certain deals 640 or user 618 in their personal information that can be transferred to other tenants.

The examples depicted by FIGS. 4-6 are illustrative only of possible processes and structural relationship flows within a multi-tenancy database system including a social networking application. Users and tenants may be configured in a multitude of different or similar configurations, and further users and tenants may store and access other information not shown here and share or communicate such information in various manners. Accordingly, it will be understood by those of ordinary skill in the art that the multi-tenant database system and/or tenants may implement various governance policies and security provisions to allow different types of information to transfer on a per user, per tenant, and/or system wide basis. Further, the governance policies and security provisions may be modified over time.

FIG. 7 depicts an exemplary computing system 700 configured to perform any one of the above-described processes. In this context, computing system 700 may include, for example, a processor, memory, storage, and input/output devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform the above-described processes. The main system 702 includes a motherboard 704 having an input/output (“I/O”) section 706, one or more central processing units (“CPU”) 708, and a memory section 710, which may have a flash memory card 712 related to it. The I/O section 706 is connected to a display 724, a keyboard 714, a disk storage unit 716, and a media drive unit 718. The media drive unit 718 can read/write a computer-readable medium 720, which can contain programs 722 and/or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. Apparatus for a multi-tenant database system having portability of user profile information across tenancies, the apparatus comprising:
a multi-tenant database system operable to store data for a plurality of tenants; and
a server, having a processor, operable to
provide access to the multi-tenant database for each of the multiple tenants, and
transfer an association of profile information of a user from a first tenant of the multi-tenant database system to a second tenant of the multi-tenant database system when the user becomes associated with the second tenant.

2. The apparatus of claim 1, wherein the profile information comprises social information.

3. The apparatus of claim 1, wherein the profile information comprises contact information of the user.

4. The apparatus of claim 1, wherein the first tenant comprises a default tenancy associated with the multi-tenant database system.

5. The apparatus of claim 1, wherein the first tenant is associated with a social networking application.

6. The apparatus of claim 1, wherein:
first information associated with the first tenant and second information associated with the second tenant are stored with the multi-tenant database system, and
the first information and the second information are logically separated within the multi-tenant database system.

7. The apparatus of claim 1, wherein transferring further comprises preventing a portion of the profile information from being transferred.

8. The apparatus of claim 1, wherein transferring comprises logically associating the profile information with the second tenant.

9. The apparatus of claim 1, wherein the user profile information is transferred in response to the user becoming associated with the second tenant.

10. The apparatus of claim 1, wherein the user profile information is transferred in response to a request by the user.

11. A computer-enabled method for transferring personal data across tenants in a multi-tenant database system, the method comprising:
transferring, via a processor, profile information associated with a user from a first tenant of a multi-tenant database system storing data for multiple tenants to a second tenant of the multitenant database system.

12. The method of claim 11, wherein the profile information comprises social information.

13. The method of claim 11, wherein the profile information comprises contact information of the user.

14. The method of claim 11, wherein transferring further comprises preventing a portion of the profile information from being transferred.

15. The method of claim 11, wherein transferring comprises logically associating the profile information with the second tenant.

16. The method of claim 11, wherein users of the first tenant do not have access to the second information and users of the second tenant do not have access to the first information.

17. The method of claim 11, wherein the user profile information is transferred in response to the user becoming associated with the second tenant.

18. The method of claim 11, wherein the user profile information is transferred in response to a request by the user.

19. Computer-readable storage medium comprising computer-executable instructions for transferring user profile data from tenant-to-tenant in a multi-tenant database system, the instructions for:
transferring profile information associated with a user from a first tenant of a multi-tenant database system storing data for multiple tenants to a second tenant of the multitenant database system.

20. The computer-readable medium of claim 19, wherein the profile information comprises social information.

21. The computer-readable medium of claim 19, wherein the profile information comprises contact information of the user.

22. The computer-readable medium of claim 19, wherein transferring further comprises preventing a portion of the profile information from being transferred.

23. The computer-readable medium of claim 19, wherein transferring comprises logically associating the profile information with the second tenant.

24. The computer-readable medium of claim 19, wherein the user profile information is transferred in response to the user becoming associated with the second tenant.

25. The computer-readable medium of claim 19, wherein the user profile information is transferred in response to a request by the user.

26. The computer-readable medium of claim 19, wherein the first tenant comprises a default tenancy associated with the multi-tenant database system.
